(19) United States
(12) Patent Application Publication
(10) Pub. No.: US 2009/0017170 A1
(43) Pub. Date: Jan. 15, 2009

(54) CRACKER-PRETZEL FOOD ITEMS AND METHODS RELATED THERETO

(76) Inventors: Brian Armstrong, Portage, MI (US); Bruce Howrey, Battle Creek, MI (US); Gerald A. Harkness, East Leroy, MI (US)

Correspondence Address: Randall L. Shoemaker;Dickinson Wright, PLLC, 38528 Woodward Ave, Ste. 2000, Bloomfield Hills, MI, 48304-5092, US

(21) Appl. No.: 12/170,729

(22) Filed: Jul. 10, 2008

Related U.S. Application Data
(60) Provisional application No. 60/948,998, filed on Jul. 11, 2007.

(51) Int. Cl. A21D 13/00

(52) U.S. Cl. 426/104; 426/549

(57) ABSTRACT

The present invention provides snack-sized or accompaniment food items with cracker texture, appearance and flavor on one side, and pretzel texture, appearance and flavor on the other side. Efficient processes are also provided for making such food items, wherein a dough is treated so as to create a dual texture. Superior intermediates and end products are therefore also provided.

### CROSS REFERENCE TO RELATED APPLICATION

This application claims the benefit of application Ser. No. 60/948,998, filed on Jul. 11, 2007.

### FIELD OF THE INVENTION

The present invention provides food items with both a cracker texture, appearance and flavor (cracker-like qualities), and a pretzel texture, appearance and flavor (pretzel-like qualities). Efficient processes are also provided for making such food items, wherein a dough is treated with a caustic solution so as to create the dual qualities upon baking. Superior intermediates are therefore also provided.

### BACKGROUND OF THE INVENTION

Crackers have been made for years, as have pretzels. Moreover, the key step in pretzel making, applying a caustic solution to the dough, has been used to modify the exterior of various doughs in the past. U.S. Patent Application Publication 2006/0057269 describes a method for browning the exterior of pre-baked dough products, including pre-baked crackers, using a second caustic treatment step.

Recently, several types of “pretzel chips” have been introduced to the market. These snacks have a pretzel texture on both sides, and are flat and thin like a chip. U.S. Pat. No. 6,254,917 discloses such a pretzel chip.

The present invention is distinct from those disclosed previously. The present food items have a dual texture, appearance and flavor, and the processes to make the present food items require a series of steps not disclosed or suggested previously. There is a need in the food industry for improved food compositions and processes, particularly those with dual cracker-pretzel qualities.

### SUMMARY OF THE INVENTION

The present invention provides food items having the dual texture, appearance and flavor of both a cracker and a pretzel, and methods to make the food items.

The food items preferably comprise one side having any style of cracker texture, appearance and flavor, and the other side a browned, firm and crisp pretzel texture, appearance and flavor. Most preferred are those dual food items that have been made from a laminated cracker dough which has been treated with a caustic solution prior to baking.

The methods to make the food items comprise applying a caustic solution to a sheeted cracker dough in such a manner as to result in a food item with dual texture, appearance and flavor when baked. Preferably, the methods of the present invention include the steps of: applying a caustic solution to one surface of a sheeted cracker dough, and then baking the dough so as to produce a cracker texture, appearance and flavor on the untreated surface, and a pretzel texture, appearance and flavor on the treated surface.

In a most preferred embodiment, the present methods include the steps of: spraying an aqueous solution of sodium hydroxide onto one side of a sheeted cracker dough at a first temperature, wherein the sodium hydroxide is at a concentration of about 0.1-7%, preferably 2-5%, most preferably 4-5% and the first temperature is about 80-150° F.; and then baking the dough at a second temperature, wherein the second temperature may be above 250° F. The present invention may also include the optional steps of oiling the food item after baking, and/or seasoning the food item, preferably with salt, before or after baking.

Intermediate, unbaked compositions are claimed herein, as are baked final products. Moreover, since the present compositions are ideally made on an industrial scale in a continuous process, the present invention also provides compositions that are treated and baked in one section of the continuous process, treated and unbaked in another section of the continuous process, or untreated and unbaked other sections of the continuous process.

The present compositions are superior to those currently available to consumers in several aspects, including: the foods taste better, are portable, have a better texture and mouthfeel, provide a unique marketing profile, and have an excellent shelf life.

Accordingly, it is an object of the present invention to provide food products having improved texture, flavor, shelf life, marketability, salability, processing efficiency and health benefits.

These and other features and advantages of this invention will become more apparent to those skilled in the art from the definitions, drawings, detailed description and examples provided herein.

### DEFINITIONS

“Cracker-like” means having a cracker type texture, flavor and surface appearance. The term does not imply any particular shape.

“Pretzel-like” means having a pretzel type flavor, texture and surface appearance. The term does not imply any particular shape or twisting.

“Unbaked” means not fully baked to a moisture content of less than 10%. “Unbaked” includes the conditions of never having been heated or partially heated.

“Weight percent” as used herein is based on the total weight of the composition unless indicated to the contrary.

Throughout the specification and claims, percentages and ratios are by weight and temperatures are in degrees Fahrenheit, unless otherwise indicated.

### DETAILED DESCRIPTION

In the present invention, the food items are formed from cracker dough.

The cracker dough used in the present invention can be any type of edible cracker dough, including, for example, laminated or non-laminated cracker dough, cracker dough with some sweeteners added, cracker doughs that are leavened, cracker doughs that have been fermented, cracker doughs with flavorings and/or cracker doughs with inclusions or toppings.

The cracker dough useful in the present invention includes those selected from the group consisting of: multi-grain; rice-based; corn-based; rye-based; soda cracker style; wheat-based; butter cracker dough; flavored dough; whole grain-based; cornmeal-based; gluten-free; graham-based; and flatbread style.

The cracker dough useful in the present invention is made according to methods generally known in the art, and includes mixing flour, fat and moisture (ordinarily water) and most often, salt. Optional ingredients, such as flavors, inclusions, colors, nutritional supplements, leavening agents, emulsifiers, etc. may be added as well. The cracker dough may then be sheeted, rolled, twisted or formed according to skill in the art, and then sprayed with a caustic solution, as described herein. For the present purposes, the resulting sheeted and sprayed dough is called an “intermediate food product” herein, and alternatively, an “intermediate” so as to distinguish the unbaked food product from the baked food product. The intermediate is then optionally baked, in the manner of pretzels and crackers, to produce a dual-textured end product having no residual caustic solution. The baked products are called “dual textured” or “finished food items” or “baked” or “cracker-pretzels” herein, to distinguish those embodiments from the unbaked intermediate embodiments. Those in the art are aware that food items, particularly dough products, are often sold unbaked and refrigerated, or unbaked and frozen, so that consumers have the option to bake them immediately prior to consumption, for maximum freshness. It is for this reason that the distinction between unbaked and baked food products is made in the description and the claims.

The present invention includes combinations of dough layers in one layered composition, for example two layers each having a different type (color, flavor, inclusions, processing differences, etc.) of cracker dough. Any particular layer itself may be a hybrid of dough types as well. Preferably, the food items of the present invention are formed from laminated cracker dough.

The flour component in cracker dough useful in the present invention may be any edible flour, including hard wheat flour, Kashi® 7-grain flour, soft wheat flour, corn flour, multi-grain flour, rye flour, rice flour, barley flour, graham flour, whole wheat flour, high amylose flour, low amylose flour, and the like. Different grain constituents lend different texture, taste, and appearance to a baked good. Flours useful herein are of a conventional type and quality including cake flour, bread flour, and all-purpose flour. Wheat flours are preferred but other flours conventionally used in the preparation of baked goods are also employed in full or partial substitution for the wheat flour. One protein range for wheat flour used in the present invention is between about 7 to 15% by weight of the flour. A general all-purpose flour is also usable. This type of all-purpose flour generally comprises a mixture of both hard and soft wheat flours, i.e., both high protein level and low protein level flours. Such flours are useful if the average protein content ranges from about 7 to 15% by weight. While chlorinated flours are used herein, unchlorinated flours are also usable because chlorination is an expensive, though unnecessary flour processing step. Unmalted flours may be used provided the flours are derived from wheats with minimal sprout damage. Enzyme inactivated flours are also usable. Flour having low polyphenol oxidase activity, flour having a flour enrichment with all reduced iron, a binder of metal ions, an organic acid, and the like are also usable in the present invention.

The fat component in a food item of the present invention comprises any edible fat, oil, or shortening, including those that are solid at room temperature and those that are liquid at room temperature. Liquid shortenings or oils are usable and provide an advantage of ease of incorporation. Solid shortening is usable and provides an advantage of desirable mouthfeel upon consumption of the baked good. More commonly used are mixtures of liquid and solid shortenings. These mixtures are fluid or plastic depending, in part, on the level of solid fatty materials. Liquid shortening includes animal shortening, marine fats, vegetable or synthetic oil, such as sucrose polyesters, which are liquid at ordinary room temperature. The fat component of the present invention may comprise natural or hydrogenated oils, including soybean oil, cottonseed oil, canola (rapeseed) oil, peanut oil, safflower oil, sesame oil, sunflower oil, poppyseed oil, coconut oil, palm oil, palm kernel oil, olive oil, butterfat, cocoa butter, tallow, lard, babassue, corn oil, or combinations thereof.

Sweeteners may optionally be added to the cracker dough, but only at levels that do not interfere with the ability of the cracker dough to form a sheet. According to the invention, any suitable sugar can be present, including liquid or dry sugars. Typical sweeteners include corn syrup, high fructose corn syrup, maltose, malt syrup, malt syrup solids, honey, maple syrup, rice syrup, rice syrup solids, sorghum syrup, refiners syrup, corn syrup solids, dextrose, fructose, crystalline fructose, galactose, glucose, lactose, sucrose, brown or invert sugars, molasses and other compositions that substantially comprise sugars, whether crystalline, syrup or other physical form, and combinations thereof. Preferably, the food items of the present invention comprise sucrose in the form of granulated sugar. Sugar substitutes can also be used according to the invention, including, for example, saccharine, acesulfone K, aspartame, sucralose, d-tagatose and the like. Such sugar substitutes can be used in addition to, or as a substitute for, the sweetener.

The food items optionally further comprise emulsifiers. Generally useful emulsifier components are partially esterified polyhydric compounds having surface active properties. This class of emulsifiers includes among others, mono and diglycerides of fatty acids, such as monopalmitin, monostearin, monoolein, and dipalmitin; partial fatty esters of glycols, such as propylene glycol monostearate and monobehenate; higher fatty acid esters of sugars, such as the partial palmitic and oleic acid esters of sucrose; and phosphoric and sulphuric acid esters, such as dodecylglyceryl ether sulfate and monostearin phosphate. Other examples include the partial esters of hydroxy carboxylic acid such as lactic, citric, and tartaric acids with polyhydric compounds, for example, glycerol lacto palmitate and the polyoxyethylene ethers of fatty esters of polyhydric alcohols, such as polyoxyethylene ether of sorbitan monostearate or distearate. Fatty acids alone or esterified with a hydroxy carboxylic acid, e.g., stearyl-2-lactylate are also useful. In certain variations, all or a portion of the emulsifier component is pre-blended with the shortening or fat component. However, in other variations, a portion of the emulsifiers can be pre-hydrated and added along with the other wet ingredients. In still other variations, the emulsifiers can be plated onto various solid carriers such as flour, starch, sugars, milk powders, and the like, and admixed in with the various dry ingredients.

The food items of the present invention also optimally comprise salt for flavor and function. Any food-grade salt is acceptable, although those in the art are aware that certain salts lend themselves to better results than others. For instance, the salt may be chosen from, but is not limited to, sodium chloride, potassium chloride, calcium chloride, naturally-occurring sea or other salts, or combinations thereof.

Food items of the present invention may also comprise a leavening component. The leavening component may be a chemical leavening agent such as ammonium bicarbonate, an acid/base system, or a fermentation leavening agent, such as yeast. An acid/base leavening component triggers a release of carbon dioxide upon contact with moisture. The carbon dioxide gas aerates the dough during mixing and baking to provide a light, porous cell structure, fine grain, and a texture with desirable appearance and palatability. Basic leavening agents suitable for use in the present invention include, for example, sodium bicarbonate and other bicarbonates and/or carbonates. Typically, sodium bicarbonate is the selected basic leavening agent because it is stable and relatively inexpensive to produce. Acidic leavening agents suitable for use in the present invention include, for example, sodium or calcium salts or ortho, pyro, and complex phosphoric acids in which at least two active hydrogen ions are attached to the molecule. Baking acids include monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-deltalactone (GDL), potassium hydrogen tartrate (cream of tartar), and the like. In one embodiment, the acidic leavening agent includes sodium aluminum phosphate. The one or more of the leavening agents may optionally be encapsulated, either the leavening base or the leavening acid, or both. The evolution of carbon dioxide essentially follows the stoichiometry of a typical acid-base reaction. The amount of basic leavening agent present determines the amount of carbon dioxide evolved, whereas the type of acidic leavening agent affects the speed at which the carbon dioxide is liberated. An excess amount of leavening base can impart a bitter flavor to the baked product while excess leavening acid can make the baked product tart.

Optionally, the present food items may comprise additional flavorant components, inclusions, and/or nutritive enhancers. Flavorants may be any of those known in the art and may include, cheese, cheese powder, yeasts, spices, paprika, garlic, herbs, flavors, fruit flavors, seeds, chocolate, etc. The resultant cracker/pretzels can be any style, including: multi-grain, water-style, nut-based, rice-based, corn-based, rye-based, whole grain, sesame, flatbread, butter-style, cream-style, hard breadstick, saltine, cheese flavor, herb flavor, fish flavor, chicken flavor, beef flavor, shrimp flavor, spice flavor, combination flavor, chemically leavened, crackers with inclusions, yeast leavened, having a nut flavor, or any combination of those.

Inclusions may be any of those known in the art and may include oats, nutmeats, seeds, candy pieces, fruit pieces, etc. Nutritive enhancers may be any of those known in the art and may include vitamins, minerals, and fiber.

The present food items may also optionally comprise enzymes, according to criteria and processes known to those in the art. For instance, proteases, lipases, carbohydrases may optionally be added, to modify the structure, function or flavor of the end product.

The cracker dough is sprayed with a caustic solution, preferably on one side of a flat surface of cracker dough. The caustic solution used in the present invention may be any that are known in the art, and include: sodium hydroxide, lye, caustic soda, potassium hydroxide, natural caustics, synthesized caustics, calcium hydroxides, sodium bicarbonate, or any other caustics useful for food preparation.

Moreover, for the purposes of the present invention, the term “caustic” is expanded to include certain chemical compositions that would not ordinarily fit the common meaning of the term, but are in accordance with the inventive purpose. The term “caustic” therefore includes food acids, particularly weak acids such as acetic acid, lactic acid, ascorbic acid and oxidants, particularly peroxides, such as hydrogen peroxide. For these types of caustics, the treated surface will have a rough, slightly pitted, whitish or bleached appearance, and will have the texture of a pretzel and appearance of a pretzel without the brown color. The exterior will be toughened and crunchy in the manner of a pretzel. These embodiments are considered “pretzel-like” for the purposes of the present invention.

The caustic concentration may be any that accomplishes the goal of causing pretzel-like attributes when applied to a cracker dough and baked. Upon reading this disclosure, those in the art would be able to modify the concentrations and application techniques (such as spraying, dipping, misting, etc) so as to accomplish the pretzel-like attributes. The present invention therefore also includes the use of caustics having from 0.1 to 10% caustic concentration, preferably 2 to 9% concentration, most preferably 4 to 7% caustic concentration, by weight of the caustic and fluid modality. Ideally, the present invention involves the use of a basic caustic in water.

The amount of caustic solution preferably applied is determined by the attributes desired, and the length of time applied prior to other handling. The varying amounts, by weight, of caustic to other ingredients (for the dough) to make an intermediate food product are described in Table 1. This table is merely a different format for describing some parameters of the present invention and is not, by itself, the full scope of the present invention. Those in the art will be able to read this disclosure and modify the disclosed parameters to obtain the same result.

TABLE I
Intermediate Food Product Composition (Caustic Treated Dough)

| | | | Most Preferred |
|---|---|---|---|
| | Preferred % by | More Preferred | % by total |
| | total weight | % by total weight | weight |
| INGREDIENT | | | |
| Flour | 40-80 | 40-70 | 60-70 |
| Fat | 0-15 | 5-10 | 7-9 |
| Moisture | 10-35 | 20-30 | 24-27 |
| Salt | 0-1 | .5-1 | .6-1 |
| Caustic Solution | .1-15 | 2-12 | 3-8 |
| Optional ingredients | | | |
| Emulsifier | 0-1 | .1-.5 | .3-.5 |
| Leavening agent | .05-4 | .05-3 | .5-1.5 |
| Sweetener | 0-15 | 1-10 | 5-7 |
| Flavorant | 0-15 | 0-10 | 0-6 |
| Inclusions | 0-10 | 0-8 | 0-5 |
| Nutritive enhancers | 0-1 | 0-.05 | 0 |
| Enzymes | 0-1 | 0-.05 | 0-.01 |
| Yeast | 0-1 | 0-.5 | 0 |
| Total | 100.00 | 100.00 | 100.00 |

According to processes described and claimed in the present invention, after an intermediate food product is prepared, it may optionally be baked to a moisture content of less than 10%. When the moisture loss from baking is taken into consideration, the finished product according to the present invention will have the parameters as described in Table II.

TABLE II
Finished Food Product Composition (Pretzel-Cracker)

| | | | Most Preferred |
|---|---|---|---|
| | Preferred % by | More Preferred | % by total |
| | total weight | % by total weight | weight |
| INGREDIENT | | | |
| Flour | 40-70 | 50-68 | 59-66 |
| Fat | 0-30 | 10-30 | 18-26 |
| Moisture | 0-9.99 | 1-6 | 1-4 |
| Salt | 0-7 | 1-5 | 1-3 |
| Optional ingredients | | | |
| Emulsifier | 0-2 | 0-1 | 0 |
| Leavening agent | 0-2 | 0-1.5 | 0 |
| Sweetener | 0-20 | 5-10 | 5-7 |
| Flavorant | 0-25 | 0-15 | 0-6 |
| Inclusions | 0-20 | 0-15 | 0 |
| Nutritive enhancers | 0-2 | 0-1 | 0 |
| Enzymes | 0-1 | .01-.05 | 0 |
| Yeast | 0-1 | .1-.5 | 0 |
| Total | 100.00 | 100.00 | 100.00 |

In the present invention, any number of configurations of cracker-pretzel dual flavor, texture and appearance are provided. In one embodiment, a flat food piece is pretzel flavor, texture and appearance on one surface, and cracker flavor, texture and appearance on the opposite surface. The pretzel-cracker need not be flat, however. The present invention includes those embodiments wherein the pretzel-cracker is curved, bumpy, or otherwise not flat. In addition, the present invention comprises those embodiments wherein the cracker-pretzel is cracker on a portion of one surface and pretzel on another portion of the same surface. Decorative features, such as stripes or designs, are within the scope of the present invention. Therefore, also provided is a food item, comprising a cracker dough having at least two surfaces, wherein a caustic solution has been applied at least some, but not all, of any given surface of said two surfaces. More preferred are those food items as described, wherein said food item has a pretzel-like surface in a shape selected from the group consisting of: at least one stripe; at least one dot; at least one letter; at least one number; at least one character; at least one geometric shape; and at least one face.

Moreover, the particular percentage of surface area devoted to pretzel-like qualities need not be limited to fifty percent, although a preferred embodiment of the present invention is one wherein one half of the surface area of the food product has cracker-like qualities and the other half has pretzel-like qualities. The present invention includes ratios of cracker-like features to pretzel like features, including 10:90, 20:80, 30:70, 40:60, 50:50, 60:40, 70:30, 80:20 and 90:10.

The inventive process results in a superior food product. Cracker dough can be prepared according to any known method, including industrial or small batch processes. The cracker dough is then shaped and portioned according to those processes know in the art. The dough can be sheeted, die-cut, hand-formed, extruded, formed via other specialized mechanical means, or some combination thereof. For instance, dough can be sheeted and then die cut, or extruded as ropes and then hand-twisted, or any variation thereof.

Co-pending, published application US 2006/0286244, assigned to the same assignee as the present application, describes many aspects of cracker production, including how to form crackers and apply oils to the surface so that the cracker may absorb the oil and benefit in flavor characteristics. US 2006/0286244 is incorporated by reference in its entirety.

The cracker dough is then subjected to application of caustic, and such application may be according to any means for applying a liquid to dough. For instance, caustic may be sprayed, dipped, misted, or applied via contact with a moist surface, such as a caustic-dipped sponge. Preferably, the caustic is applied via spraying.

Salt may optionally be applied topically, at this stage, although it may also be applied before or after. Preferably, salt is applied after application of caustic solution, so as to adhere the salt to the dough.

The caustic-treated cracker dough may then be packaged and sold as an intermediate product, either refrigerated or frozen, for subsequent baking by the consumer baking. Alternatively, the intermediate product can be baked prior to packaging, and distributed as a finished product. Baking can be accomplished according to any known means, and preferably includes at least one stage at 300° F. or less, and may also include a stage at a higher temperature, even up to 500° F. or more. Most preferably, baking takes place in a band oven with several stages of baking temperatures, ranging from around 300° F. to around 500° F.

During the baking process, the caustic-treated intermediate browns and becomes crisp like a pretzel on a caustic treated surface, and bakes like a cracker on a untreated surface. Remarkably, the cracker side is flaky and the pretzel side is crunchy. The layers retain their properties and are shelf stable.

A preferred embodiment of the present invention is a cracker-pretzel wherein the cracker surface has been supplemented with an application of oil after baking, preferably when the cracker/pretzel is still hot. Oil may be applied in any method known in the art and includes spraying, dipping, application by an oil-soaked medium, such as a sponge, or any other application method that would result in oil selectively being applied to the cracker surface. This application of oil is absorbed and provides additional flavor complexity, preferably at a rate of 0-25% by weight of the end product, more preferably 5-20% and most preferably at a rate of 10-15% by weight.

Any oil may be used, although those with the flavor and absorption qualities for the particular product may be modified as is known in the art. In particular, topical oils may be selected from natural, or chemically enhanced oils, including soybean oil, cottonseed oil, canola (rapeseed) oil, peanut oil, safflower oil, sesame oil, sunflower oil, poppyseed oil, coconut oil, palm oil, palm kernel oil, olive oil, butterfat, cocoa butter, tallow, lard, babassue, corn oil, or combinations thereof.

### EXAMPLES

### Example 1

### Preparation of a Caustic Solution

A 4-7% caustic solution is prepared by mixing the appropriate amount of 50% caustic solution with water.

### Example 2

### Preparation of an Intermediate Product Using Various Flours and Dill

| CRACKER DOUGH INGREDIENTS | MEASUREMENT | |
|---|---|---|
| unbleached white flour | 2 | cups |
| whole wheat flour | .5 | cup |
| rye flour | .5 | cup |
| salt | 1 | teaspoon |
| butter, softened | .5 | cup |
| warm water | .5 | cup |
| finely snipped dill leaves | 3 | tablespoons |
| salt | 1 | teaspoon |
| dill seed | 1 | teaspoon |

The flours and one teaspoon salt are mixed in a large bowl. The softened butter is processed in a food processor with the flour and salt mixture to make a fine meal. The warm water and dill leaves are mixed into the flour, salt and butter mixture. The dough is kneaded for five minutes, then rolled on a lightly floured surface into a ⅛ inch thick rectangle. The dough is cut into three inch by 1.5 inch pieces, pricked with a fork, and sprayed with the caustic of Example 1. The pieces are then salted with the additional one teaspoon salt for the batch.

### Example 3

### Preparation of an Intermediate Product Using Graham Cracker Dough

| CRACKER DOUGH | | |
|---|---|---|
| INGREDIENTS | MEASUREMENT | |
| oil | ¼ | cup |
| honey | ⅓ | cup |
| molasses | 2 | tablespoons |
| vanilla | 1 | teaspoon |
| whole wheat flour | 2½ | cup |
| baking powder | 1 | teaspoon |
| salt | ¼ | teaspoon |
| cinnamon | 1 | teaspoon |
| milk | ¼ to ½ | cup |

Oil, honey, molasses and vanilla are mixed in a first bowl. Flour, baking powder, salt and cinnamon are combined in a second bowl. The dry mix is added to the liquids, alternating with milk. The combination is mixed well. The dough is divided in half and rolled directly onto baking sheet. The top surface of dough is sprayed with caustic solution of Example 1, pricked with a fork and cut into 2.5 inch squares.

### Example 4

### Preparation of an Intermediate Product Using Butter Cracker Dough

| CRACKER DOUGH | | |
|---|---|---|
| INGREDIENTS | MEASUREMENT | |
| flour | 3 | cup |
| unsalted butter | ¾ | cup |
| sugar | 3 | tablespoons |
| salt | 1½ | teaspoons |
| milk | 1 | cup |

The first flour ingredients are crumbled together. Enough milk is then added and stirred to make a stiff dough. The dough is rolled as thin as possible and sprayed with the caustic solution of Example 1. The dough is then cut into oval shapes and pricked with a fork.

### Example 5

### Preparation of an Intermediate Product Using Bacon and Cheese in a Dough

| CRACKER DOUGH | | |
|---|---|---|
| INGREDIENTS | MEASUREMENT | |
| bacon, cooked and crumbled | ¼ | pound |
| all-purpose flour | 1½ | cup |
| cheddar cheese, shredded | ½ | cup |
| parmesan cheese, grated | 2 | tablespoons |
| baking soda | ½ | teaspoon |
| salt | ¼ | teaspoon |
| black pepper, ground | ⅛ | teaspoon |
| sour cream | ½ | cup |
| bacon drippings | 3 | tablespoons |

Bacon, flour, cheeses, baking soda, salt and pepper are combined in a bowl. Sour cream is stirred into the combination. Bacon drippings are stirred into the combination. The dough is rolled into a ⅛ inch thick sheet, sprayed with the caustic solution of Example 1, cut into 1½ inch diamonds, and sprinkled with grated parmesan cheese.

### Example 6

### Preparation of Cracker/Pretzel Products

Intermediates of Examples 3, 4 and 5 are baked on a cookie sheet at around 325° F. for 25 minutes, turning once after 15 minutes. Alternatively, the Intermediates of Examples 3, 4 and 5 are baked on a mesh pan at around 400° F. for approximately 10 minutes, without turning. Alternatively, the Intermediates of Examples 3, 4, and 5 are baked in a band oven at around 350° F. for approximately 15 minutes. The resulting cracker/pretzels have a dual texture.

### Example 7

### Surface Oil Augmentation of Cracker/Pretzel Products

Baked Cracker/Pretzel products prepared according to Example 6 are brushed with soybean oil so as to avoid the pretzel surfaces, at a rate of 15%, measured by weight of the oil to cracker/pretzel. After the oil supplements the cracker by absorption, the resulting cracker/pretzel becomes more rich in flavor compared to the un-oiled cracker/pretzel products.

The foregoing invention has been described in accordance with the relevant legal standards, thus the description is exemplary rather than limiting in nature. Variations and modifications to disclosed embodiments may become apparent to those skilled in the art and are within the scope of the invention.

What is claimed is:

1. A food item, comprising a cracker dough having at least two surfaces, wherein a caustic solution has been applied to at least one, but less than all, of said surfaces.

2. The food item of claim 1, wherein the food item has been baked after applying the caustic solution.

3. The food item of claim 1, wherein said caustic solution is a 0.1 to 10% aqueous solution.

4. The food item of claim 1, wherein said caustic solution is 0.1 to 15% of the total weight of the food item after application.

5. The food item of claim 4, wherein said caustic solution is 2-12% of the total weight of the food item after application.

6. The method of claim 5, wherein said caustic solution is 4-7% of the total weight of the food item after application.

7. A dual-textured food item, comprising at least one cracker-like surface and at least one pretzel-like surface.

8. A food item of claim 7, comprising one cracker-like surface, and one pretzel-like surface.

9. A food item of claim 8, wherein the cracker-like surface has been supplemented with topical oil.

10. A food item of claim 9, wherein the pretzel-like surface further comprises topical salt.

11. A method of making a dual-textured food item, comprising applying aqueous, food-grade caustic to less than all surfaces of cracker dough.

12. A method of claim 11, wherein said caustic is applied to one surface of a flat piece of cracker dough.

13. A method of claim 11, comprising a further step of baking said caustic-applied dough.

14. A method of claim 12, wherein said baking results in a moisture content of less than 10%.

15. A method of claim 14, wherein said moisture content is less than 5%.

16. A method of claim 13, wherein said baking results in a crispy textured food item.

17. A method of claim 12, comprising a further step of applying topical salt to the caustic-applied surface of the cracker dough.

18. A method of claim 17, comprising a further step of baking the cracker dough, so as to produce a cracker-like surface and a salted, pretzel-like surface.

19. A method of claim 18, comprising a further step of applying topical oil to the cracker-like surface.

20. A method of claim 11, wherein the cracker dough is a dough selected from the group consisting of: multi-grain; water-style; nut-based; rice-based; corn-based; rye-based; whole grain; sesame; flatbread; butter-style; cream-style; hard breadstick; saltine; cheese flavor; herb flavor; fish flavor; chicken flavor; beef flavor; shrimp flavor; spice flavor; combination flavor; chemically leavened; crackers with inclusions; yeast leavened; and nut flavor.

21. A method of claim 11, wherein said aqueous caustic solution is sodium hydroxide in water.

22. A method of claim 21, wherein said sodium hydroxide solution is 4-7% by weight of said food item.

23. A food item, comprising a cracker dough having at least two surfaces, wherein a caustic solution has been applied to some, but not all, of any given surface of said two surfaces.

24. A food item of claim 23, wherein said food item has a pretzel-like surface in a shape selected from the group consisting of: at least one stripe; at least one dot; at least one letter; at least one number; at least one character; at least one geometric shape; and at least one face.
